(19) United States
(12) Patent Application Publication
(10) Pub. No.: US 2018/0144570 A1
(43) Pub. Date: May 24, 2018

(54) VEHICLE COMMUNICATION SYSTEM AND ON-BOARD DEVICE

(71) Applicants: AutoNetworks Technologies, Ltd., Yokkaichi, Mie (JP); Sumitomo Wiring Systems, ltd., Yokkaichi, Mie (JP); SUMITOMO ELECTRIC INDUSTRIES, LTD., Osaka-shi, Osaka (JP)

(72) Inventor: Norichika Oomi, Yokkaichi, Mie (JP)

(21) Appl. No.: 15/579,004

(22) PCT Filed: Jun. 2, 2016
(86) PCT No.: PCT/JP2016/066350

§ 371 Date: Dec. 1, 2017

(30) Foreign Application Priority Data
Jun. 4, 2015 (JP) 2015-114028

(51) Int. Cl. G07C 9/00; B60R 25/24; B60W 40/02

(52) U.S. Cl. CPC G07C 9/00309; B60R 25/245; B60R 2325/105; G07C 2209/63; G07C 2009/00507; B60W 40/02

(57) ABSTRACT

A vehicle communication system and an on-board device configured to open a vehicle door includes: an on-board device outputting a control signal for opening a vehicle door; and a mobile device transmitting a reservation signal for opening the vehicle door to the on-board device. The on-board device includes: a reservation signal reception unit receiving the reservation signal; a request signal transmission unit transmitting a request signal requesting a response signal from the mobile device upon the reservation signal being received; a response signal reception unit receiving the response signal transmitted from the mobile device in response to the request signal transmitted by the request signal transmission unit; a detection unit detects a positional relationship between the mobile device and a vehicle that indicates that a distance between the mobile device and the vehicle is shorter than or equal to a predetermined distance.

### CROSS-REFERENCE TO RELATED APPLICATIONS

This application is the U.S. national stage of PCT/JP2016/066350 filed Jun. 2, 2016, which claims priority of Japanese Patent Application No. JP 2015-114028 filed Jun. 4, 2015.

### TECHNICAL FIELD

The present application relates to a vehicle communication system and an on-board device that output a control signal for opening a vehicle door depending on the position at which a sender of a reservation signal pertaining to a reservation for opening a vehicle door is present.

### BACKGROUND

There is a conventionally-known on-board device that automatically opens a vehicle door even if the vehicle door is not operated by a user. JP 2009-24454A discloses an on-board device (a vehicle-side control apparatus) that detects whether or not a user is present near a vehicle door upon detecting a specific reservation signal from a mobile device (an instruction apparatus), and opens the vehicle door upon detecting the presence of the user. According to the on-board device disclosed in JP 2009-24454A, a transmitter that is provided on each vehicle door transmits a request signal, and upon a tuner that is provided in the cabin of the vehicle receiving a response signal that is a response from the mobile device to the request signal, the on-board device detects that the user is present near a vehicle door. Therefore, the on-board device disclosed in JP 2009-24454A can automatically open a vehicle door when the user who is holding the mobile device enters the communication range of a transmitter.

However, the on-board device disclosed in JP 2009-24454A, upon receiving a response signal, cannot detect where the mobile device is present in the communication range of the transmitter. That is, the on-board device opens a vehicle door regardless of where the user who holds the mobile device is present in the communication range. Therefore, if the communication range is too wide, the on-board device opens the vehicle door too early, which is not desirable in terms of security, and if the communication range is too narrow, the on-board device opens the vehicle door too late, which degrades convenience. Therefore, the on-board device disclosed in JP 2009-24454A is problematic in that it cannot flexibly perform control to open a vehicle door.

An object of the present application is to provide a vehicle communication system and an on-board device that can flexibly perform control to open a vehicle door.

### SUMMARY

A vehicle communication system according to one aspect of the present invention is a vehicle communication system including: an on-board device that outputs a control signal for opening a vehicle door; and a mobile device that transmits a reservation signal pertaining to a reservation for opening the vehicle door to the on-board device, the on-board device outputting the control signal according to a position where the mobile device is present, upon receiving the reservation signal. The on-board device includes: a reservation signal reception unit that receives the reservation signal; a request signal transmission unit that transmits a request signal that requests for a response signal from the mobile device; a response signal reception unit that receives the response signal that has been transmitted from the mobile device in response to the request signal that has been transmitted by the request signal transmission unit; a detection unit that detects a positional relationship between the mobile device and a vehicle on which the on-board device is mounted, upon the response signal reception unit receiving the response signal from the mobile device, based on the received response signal; and an output unit that outputs the control signal if the reservation signal reception unit receives the reservation signal and the positional relationship detected by the detection unit indicates that a distance between the mobile device and the vehicle is shorter than or equal to a predetermined distance.

An on-board device according to one aspect of the present invention is an on-board device that receives a reservation signal pertaining to a reservation for opening a vehicle door, and outputs a control signal for opening the vehicle door depending on a position where a sender of the received reservation signal is present, the on-board device including: a reservation signal reception unit that receives the reservation signal; a request signal transmission unit that transmits a request signal that requests for a response signal from the sender; a response signal reception unit that receives the response signal that has been transmitted from the sender in response to the request signal that has been transmitted by the request signal transmission unit; a detection unit that detects a positional relationship between the sender and a vehicle on which the on-board device is mounted, upon the response signal reception unit receiving the response signal from the sender, based on the received response signal; and an output unit that outputs the control signal if the reservation signal reception unit receives the reservation signal and the positional relationship detected by the detection unit indicates that a distance between the sender and the vehicle is shorter than or equal to a predetermined distance.

Note that the present application can be realized not only as a vehicle communication system and an on-board device that are provided with such characteristic processing units, but also as a vehicle communication method that includes the steps of performing such characteristic processing, and can be realized as a program for causing a computer to execute such steps. Also, the present application can be realized as a semiconductor integrated circuit that realizes part or all of the vehicle communication system and the on-board device, and can be realized as another system that includes the vehicle communication system and the on-board device.

### Advantageous Effects of Invention

With the above-described configurations, it is possible to provide a vehicle communication system and an on-board device that can flexibly perform control to open a vehicle door.

### BRIEF DESCRIPTION OF DRAWINGS

FIG. 1 is a schematic diagram showing an example of a configuration of a vehicle communication system according to a first embodiment.

FIG. 2 is a block diagram showing an example of a configuration of an on-board device.

FIG. 3 is a block diagram showing an example of a configuration of a mobile device.

FIG. 4 is a conceptual diagram showing an example of usage of the vehicle communication system.

FIG. 5 is a flowchart showing processing procedures that are performed by the on-board device to open a sliding door based on a reservation signal from the mobile device.

FIG. 6 is a block diagram showing an example of a configuration of an on-board device according to a second embodiment.

FIG. 7 is a conceptual diagram showing an example of a correspondence table that is stored in a storage unit.

FIG. 8 is a flowchart showing processing procedures that are performed by the on-board device to open a sliding door based on a reservation signal from a mobile device.

### DETAILED DESCRIPTION OF PREFERRED EMBODIMENTS

First, embodiments of the present invention will be listed and described. It is possible to combine at least some of the embodiments shown below as appropriate.

(1) A vehicle communication system according to one aspect of the present invention is a vehicle communication system including: an on-board device that outputs a control signal for opening a vehicle door; and a mobile device that transmits a reservation signal pertaining to a reservation for opening the vehicle door to the on-board device, the on-board device outputting the control signal according to a position where the mobile device is present, upon receiving the reservation signal. The on-board device includes: a reservation signal reception unit that receives the reservation signal; a request signal transmission unit that transmits a request signal that requests for a response signal from the mobile device; a response signal reception unit that receives the response signal that has been transmitted from the mobile device in response to the request signal that has been transmitted by the request signal transmission unit; a detection unit that detects a positional relationship between the mobile device and a vehicle on which the on-board device is mounted, upon the response signal reception unit receiving the response signal from the mobile device, based on the received response signal; and an output unit that outputs the control signal if the reservation signal reception unit receives the reservation signal and the positional relationship detected by the detection unit indicates that a distance between the mobile device and the vehicle is shorter than or equal to a predetermined distance.

In the present application, the on-board device receives a reservation signal, using the reservation signal reception unit. The on-board device transmits a request signal that requests a response signal from the mobile device, using the request signal transmission unit. The on-board device receives the response signal that has been transmitted from the mobile device in response to the request signal that has been transmitted by the request signal transmission unit, using the response signal reception unit. Upon the response signal reception unit receiving the response signal from the mobile device, the on-board device detects the positional relationship between the mobile device and the on-board device or the vehicle on which the on-board device is mounted, based on the received response signal, using the detection unit. Using the output unit, the on-board device outputs the control signal for opening a vehicle door if the reservation signal reception unit receives the reservation signal and the positional relationship detected by the detection unit indicates that a distance between the vehicle and the mobile device is shorter than or equal to a predetermined distance. Therefore, the on-board device can perform control to open the vehicle door on the condition that the positional relationship between the vehicle and the mobile device, detected by the detection unit, indicates a positional relationship in which the user who is holding the mobile device is present at a distance that is at least shorter than or equal to the predetermined distance, from the vehicle. Therefore, it is possible to perform more flexible control compared to control that is performed to open the vehicle door simply depending on whether or not the mobile device is present within a predetermined communication range.

(2) It is preferable that the on-board device further includes an environment detection unit that detects an external environment around the vehicle, and the predetermined distance is a distance that corresponds to the external environment detected by the environment detection unit.

In the present application, the on-board device detects the external environment around the vehicle on which the on-board device is mounted, using the environment detection unit. The predetermined distance is a distance that corresponds to the external environment detected by the environment detection unit. Therefore, the on-board device can change the condition for opening the vehicle door, i.e., the distance between the vehicle and the mobile device, depending on the external environment around the vehicle on which the on-board device is mounted, which realizes more flexible control and further improves user convenience.

(3) It is preferable that the environment detection unit detects whether it is raining or not at a position where the vehicle is present, and the predetermined distance has been set to be shorter for a case where the environment detection unit detects that it is raining than for cases where the environment detection unit detects that it is not raining.

In the present application, the environment detection unit of the on-board device detects whether it is raining or not at the position where the vehicle on which the on-board device is mounted is present. The predetermined distance has been set to be shorter for a case where the environment detection unit detects that it is raining than for cases where the environment detection unit detects that it is not raining. That is, the timing at which the vehicle door opens is later in the case where it is raining than in the case where it is not raining. Therefore, the on-board device can shorten the time during which raindrops can enter the vehicle, and perform more flexible control. Since the on-board device performs such control, it is possible to prevent the cabin of the vehicle from getting dirty due to raindrops, and prevent electrical equipment that is provided in the cabin of the vehicle from breaking down, for example.

(4) It is preferable that the request signal transmission unit transmits the request signal from a plurality of antennas that are provided in the vehicle.

In the present application, the request signal transmission unit of the on-board device transmits a request signal from a plurality of antennas that are provided in the vehicle. In the case of receiving a plurality of request signals, the mobile device can increase the amount of information that can be contained in a response signal to be transmitted, compared to the case of receiving one position detection signal. Therefore, the on-board device can accurately detect the positional relationship between the vehicle and the mobile device. Note that the mobile device may output a response signal to the on-board device every time a request signal from each transmission antenna is received, or output one response signal in response to request signals from the transmission antennas.

(5) It is preferable that the mobile device includes: a request signal reception unit that receives the request signal transmitted from the on-board device; a measurement unit that measures a reception signal strength of the request signal received by the request signal reception unit; and a response signal transmission unit that transmits the response signal that contains the reception signal strength measured by the measurement unit, and the detection unit of the on-board device detects the positional relationship based on the reception signal strength contained in the response signal.

In the present application, the mobile device receives the request signal transmitted from the on-board device, using the request signal reception unit. The mobile device measures the reception signal strength of the request signal received by the request signal reception unit, using the measurement unit. The mobile device transmits the response signal containing the reception signal strength measured by the measurement unit, using the response signal transmission unit. The detection unit of the on-board device detects the positional relationship between the mobile device and the vehicle on which the on-board device is mounted, based on the reception signal strength contained in the response signal. Therefore, the on-board device can accurately detect the positional relationship between the vehicle and the mobile device based on the reception signal strength.

(6) It is preferable that the request signal transmission unit intermittently transmits the request signal upon the on-board device receiving the reservation signal.

In the present application, the transmission of the request signal is triggered by the reception of the reservation signal. Therefore, it is possible to suppress power consumption.

(7) It is preferable that the mobile device transmits an activation signal for activating a driving source of a vehicle on which the on-board device is mounted, to the vehicle.

In the present application, the mobile device transmits an activation signal for activating a driving source of a vehicle on which the on-board device is mounted, to the vehicle. Therefore, by using a radio wave for transmitting the activation signal to transmit the reservation signal, for example, the mobile device according to the present application can be formed using an existing communication device for a vehicle.

(8) An on-board device according to one aspect of the present invention is an on-board device that receives a reservation signal pertaining to a reservation for opening a vehicle door, and outputs a control signal for opening the vehicle door depending on a position where a sender of the received reservation signal is present, the on-board device including: a reservation signal reception unit that receives the reservation signal; a request signal transmission unit that transmits a request signal that requests for a response signal from the sender; a response signal reception unit that receives the response signal that has been transmitted from the sender in response to the request signal that has been transmitted by the request signal transmission unit; a detection unit that detects a positional relationship between the sender and a vehicle on which the on-board device is mounted, upon the response signal reception unit receiving the response signal from the sender, based on the received response signal; and an output unit that outputs the control signal if the reservation signal reception unit receives the reservation signal and the positional relationship detected by the detection unit indicates that a distance between the sender and the vehicle is shorter than or equal to a predetermined distance.

In the present application, the reservation signal reception unit receives a reservation signal. The request signal transmission unit transmits a request signal that requests a response signal from the sender. The response signal reception unit receives the response signal that has been transmitted from the sender in response to the request signal that has been transmitted by the request signal transmission unit. The detection unit detects a positional relationship between the sender and a vehicle on which the on-board device is mounted, upon the response signal reception unit receiving the response signal from the sender, based on the received response signal. The output unit outputs the control signal for opening the vehicle door if the reservation signal reception unit receives the reservation signal and the positional relationship detected by the detection unit indicates that a distance between the sender and the vehicle on which the on-board device is mounted is shorter than or equal to a predetermined distance. The on-board device outputs the control signal for opening the vehicle door if the positional relationship detected by the detection unit matches the positional relationship, using the output unit. The on-board device can perform control to open the vehicle door on the condition that the positional relationship between the vehicle and the sender of the reservation signal, detected by the detection unit, is present at a distance that is at least shorter than or equal to the predetermined distance. Therefore, it is possible to perform more flexible control compared to control that is performed to open the vehicle door simply depending on whether or not the sender is present within a predetermined communication range.

The following describes specific examples of a vehicle communication system and an on-board device according to embodiments of the present invention with reference to the drawings. Note that the present invention is not limited to these examples. The scope of the present invention is indicated by the claims, and all changes which fall within the meaning and range of equivalency of the claims are intended to be embraced therein.

### First Embodiment

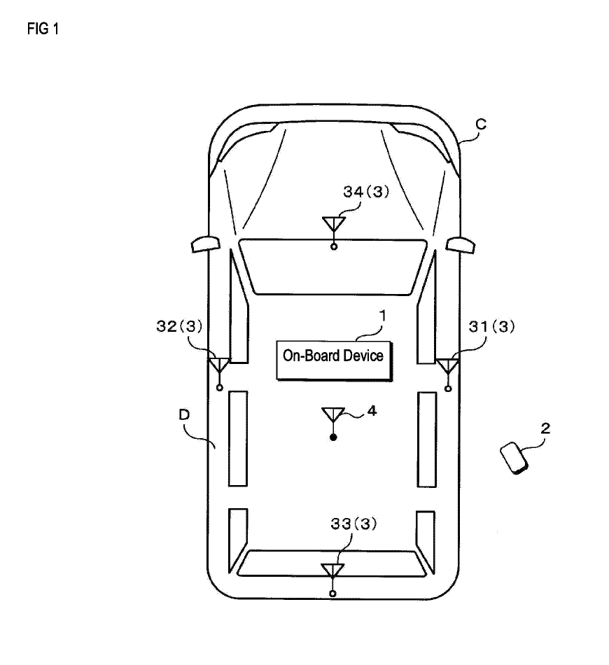

FIG. 1 is a schematic diagram showing an example of a configuration of a vehicle communication system according to a first embodiment. A vehicle communication system according to the first embodiment includes: an on-board device 1 that transmits and receives various kinds of signals via a plurality of LF transmission antennas 3 and an RF reception antenna 4, which are provided on a vehicle C; and a mobile device 2 that transmits and receives the signals to and from the on-board device 1. The on-board device 1 detects a positional relationship between the vehicle C and the mobile device 2 upon receiving a reservation signal, which will be described later, from the mobile device 2 via the RF reception antenna 4, and automatically opens a sliding door D that is provided in the vehicle C, based on the detected positional relationship. The sliding door D is provided on the passenger seat side in a rear portion of the vehicle C, for example. An additional sliding door D may be provided on the driver seat side in the rear portion, and the positions and the number of the sliding doors D are not specifically limited. Note that the left side of the vehicle C facing in the travelling direction is the passenger seat side, and the right side of the vehicle C facing in the travelling direction is the driver seat side.

The plurality of LF transmission antennas 3 include, for example: a first LF transmission antenna 31 that is provided on a driver seat side pillar; a second LF transmission antenna 32 that is provided on a passenger seat side pillar; a third LF transmission antenna 33 that is provided in the rear portion of the vehicle C; and a fourth LF transmission antenna 34 that is provided in a front portion of the vehicle C. Each LF transmission antenna 3 transmits signals using, for example, a radio wave in the LF (Low Frequency) band of 30 kHz to 300 kHz.

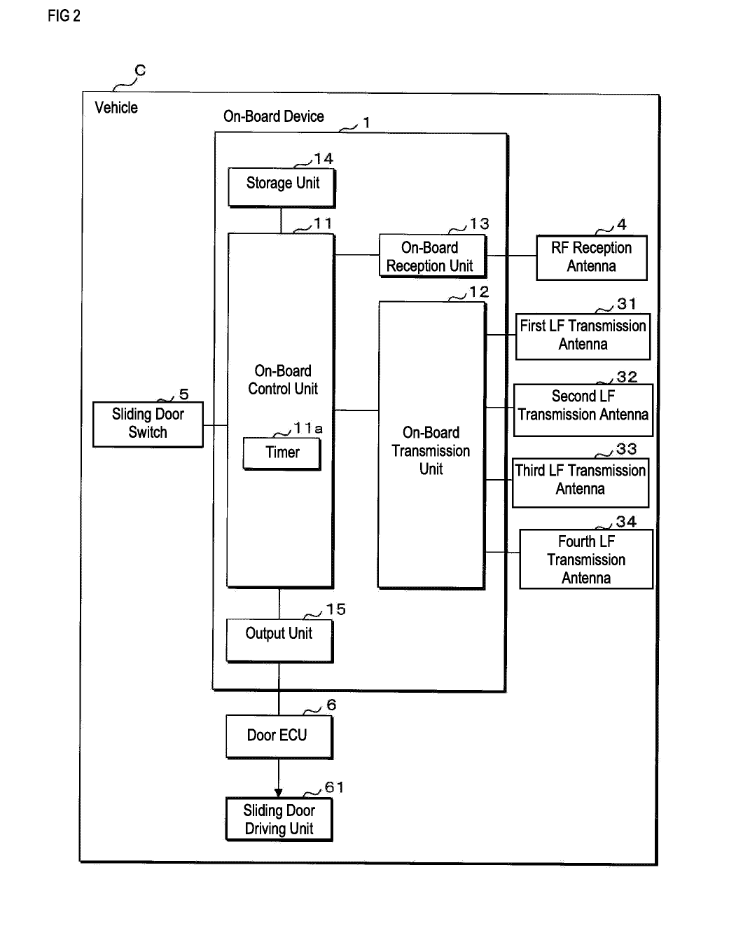

FIG. 2 is a block diagram showing an example of the configuration of the on-board device 1. An on-board control unit 11 is a computer that includes, for example, one or more CPUs (Central Processing Units), a multi-core CPU, a ROM (Read Only Memory), a RAM (Random Access Memory), an input/output interface, and a timer 11a. An on-board transmission unit 12, an on-board reception unit 13, a storage unit 14, and an output unit 15 are connected to the CPUs of the on-board control unit 11 via the input/output interface. The on-board control unit 11 executes the below-described control program that is stored in the storage unit 14 to control the operations of each constituent unit, to detect the positional relationship between the vehicle C and the mobile device 2, and to provide an instruction to open the sliding door D based on the detected positional relationship.

The storage unit 14 is a non-volatile memory such as an EEPROM (Electrically Erasable Programmable ROM) or a flash memory. The storage unit 14 stores a control program that enables the on-board control unit 11 to control the operations of each constituent unit of the on-board device 1, to detect the positional relationship between the vehicle C and the mobile device 2, and to provide an instruction to open the sliding door D.

The storage unit 14 also stores a predetermined positional relationship of the mobile device 2 relative to the vehicle C, which serves as a condition for providing an instruction to open the sliding door D. The predetermined positional relationship includes, for example, a distance from the vehicle C to the mobile device 2, and the direction of the mobile device 2 relative to the vehicle C. For example, the storage unit 14 stores information indicating a range of 3 m or less from the outer surface of the sliding door D in a direction in which the outer surface faces, as information indicating the predetermined positional relationship. Although an example in which the positional relationship has been stored in the storage unit 14 in advance will be described in the first embodiment, a configuration that allows a user to store a given positional relationship in the storage unit 14 may be employed. Although the on-board control unit 11 and the storage unit 14 in FIG. 2 are illustrated as separate constituent units, the storage unit 14 may be provided inside the on-board control unit 11.

The on-board transmission unit 12 is connected to the plurality of LF transmission antennas 3, and transmits a position detection signal for detecting the positional relationship between the vehicle C and the mobile device 2 according to control that is performed by the on-board control unit 11. The position detection signal is, for example, a signal that requests the mobile device 2 to detect a reception signal strength, and to transmit a response signal that contains the detected reception signal strength. The position detection signal corresponds to the request signal, and the on-board transmission unit 12 corresponds to the request signal transmission unit.

The on-board reception unit 13 is connected to the RF reception antenna 4, receives various kinds of signals that include a reservation signal and a response signal that have been transmitted from the mobile device 2 using a radio wave in the UHF (Ultra High Frequency) band of 300 MHz to 3 GHz, and outputs the signals to the on-board control unit 11. Since the communicable range of radio waves in the UHF band is wide, the position of the RF reception antenna 4 in the vehicle C is not specifically limited. The on-board reception unit 13 corresponds to the reservation signal reception unit and the response signal reception unit.

A door ECU 6 is connected to the output unit 15, and the output unit 15 outputs a control signal for opening and closing the sliding door D according to control that is performed by the on-board control unit 11. Specifically, the output unit 15 outputs, to the door ECU 6, a door open instruction signal that provides an instruction to open the sliding door D, and a door close instruction signal that provides an instruction to close the sliding door D. The door ECU 6 drives a sliding door driving unit 61 to open the sliding door D according to the door open instruction signal output from the output unit 15 of the on-board device 1. Similarly, the door ECU 6 drives the sliding door driving unit 61 to close the sliding door D according to the door close instruction signal output from the output unit 15 of the on-board device 1. The sliding door D includes a sliding door portion and a slide mechanism that moves the sliding door portion in a door opening direction or a door closing direction, and the sliding door driving unit 61 is provided with a power source such as a motor for driving the slide mechanism. The sliding door driving unit 61 drives the slide mechanism using the motor to move the sliding door portion in the door opening direction or the door closing direction.

Also, a sliding door switch 5 is connected to the on-board control unit 11, and a door signal that corresponds to the operational state of the sliding door switch 5 is input to the on-board control unit 11. The on-board control unit 11 can recognize the operational state of the sliding door switch 5 based on a door signal from the sliding door switch 5. Upon the sliding door switch 5 being operated, the on-board control unit 11 transmits a door open instruction signal or a door close instruction signal to the door ECU 6 using the output unit 15, to open or close the sliding door D.

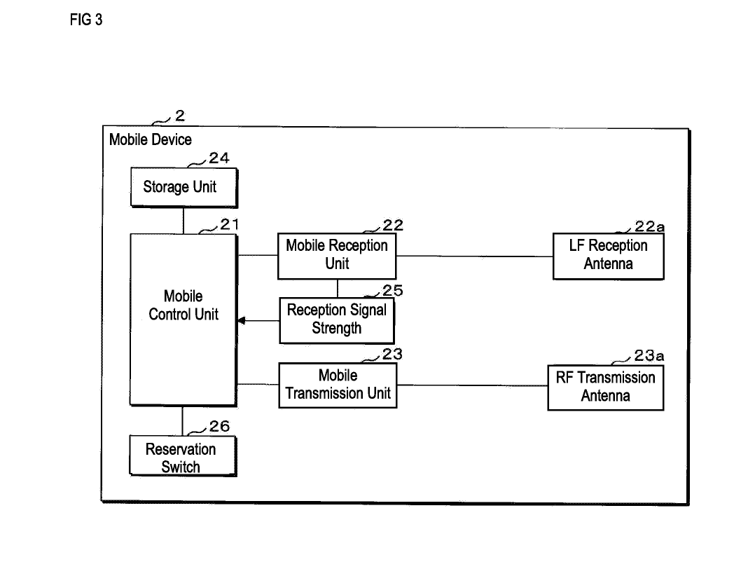

FIG. 3 is a block diagram showing an example of the configuration of the mobile device 2. The mobile device 2 includes a mobile control unit 21 that controls the operations of each constituent unit of the mobile device 2. The mobile control unit 21 is a microcomputer that includes, for example, one or more CPUs and a multi-core CPU. A mobile reception unit 22, a mobile transmission unit 23, a storage unit 24, a reception signal strength measurement unit 25, and a reservation switch 26 are connected to the CPUs of the mobile control unit 21 via an input/output interface.

The mobile control unit 21 executes processing to transmit information that is necessary for the detection of the positional relationship of the mobile device 2 relative to the on-board device 1, by reading out the below-described control program that is stored in the storage unit 24 and controlling the operations of each constituent unit.

The storage unit 24 is a non-volatile memory that is similar to the storage unit 14. The storage unit 24 stores a control program that enables the mobile control unit 21 to control each constituent unit of the mobile device 2 to execute processing to transmit a response signal and so on including information for specifying a change in the position of the mobile device 2, to the on-board device 1.

The mobile reception unit 22 is connected to an LF reception antenna 22a, receives a position detection signal that has been transmitted from the on-board device 1 using a radio wave in the LF band, and outputs the position detection signal to the mobile control unit 21. The LF reception antenna 22a is a three-axis antenna, for example, and can acquire a certain reception signal strength regardless of the direction or orientation of the mobile device 2 relative to the vehicle C. The mobile reception unit 22 corresponds to the request signal reception unit.

The reception signal strength measurement unit 25 is a circuit that detects the reception signal strength of each of the position detection signals that have been transmitted from the plurality of LF transmission antennas 3 and have been received by the LF reception antenna 22a, and outputs the detected reception signal strengths to the mobile control unit 21. The reception signal strength measurement unit 25 corresponds to the measurement unit.

The mobile transmission unit 23 is connected to an RF transmission antenna 23a, and transmits a signal that corresponds to a signal that has been transmitted from the mobile device 2, according to control that is performed by the mobile control unit 21. Specifically, upon the below-described reservation switch 26 being operated, the mobile transmission unit 23 transmits a reservation signal using a radio wave in the UHF band, according to control that is performed by the mobile control unit 21. A reservation signal is a signal for causing the on-board device 1 to start detecting the positional relationship between the vehicle C and the mobile device 2. Also, upon the mobile device 2 receiving a position detection signal, the mobile transmission unit 23 transmits a response signal using a radio wave in the UHF band, according to control that is performed by the mobile control unit 21. A response signal contains the reception signal strength measured by the reception signal strength measurement unit 25, which is information for the on-board device 1 to detect the positional relationship between the vehicle C and the mobile device 2.

Furthermore, the mobile transmission unit 23 transmits, to the vehicle C, an activation signal for activating a driving source (not shown) of the vehicle C, such as an engine or a travelling motor, according to control that is performed by the mobile control unit 21. An activation signal is transmitted using a radio wave in the UHF band, for example. Here, when transmitting a reservation signal and a response signal, the mobile transmission unit 23 uses a radio wave that is similar to the radio wave for an activation signal. A radio wave that is similar to the radio wave for an activation signal is, for example, similar in terms of frequency, strength, and modulation method.

Note that the UHF band is an example of a radio wave band that is used to transmit a signal, and the radio wave band is not limited to the UHF band. The mobile transmission unit 23 corresponds to the response signal transmission unit.

The reservation switch 26 is connected to the mobile control unit 21. An operation signal is input to the mobile control unit 21 upon the reservation switch 26 being operated. Upon receiving an input operation signal, the mobile control unit 21 performs control to cause the mobile transmission unit 23 to transmit a reservation signal.

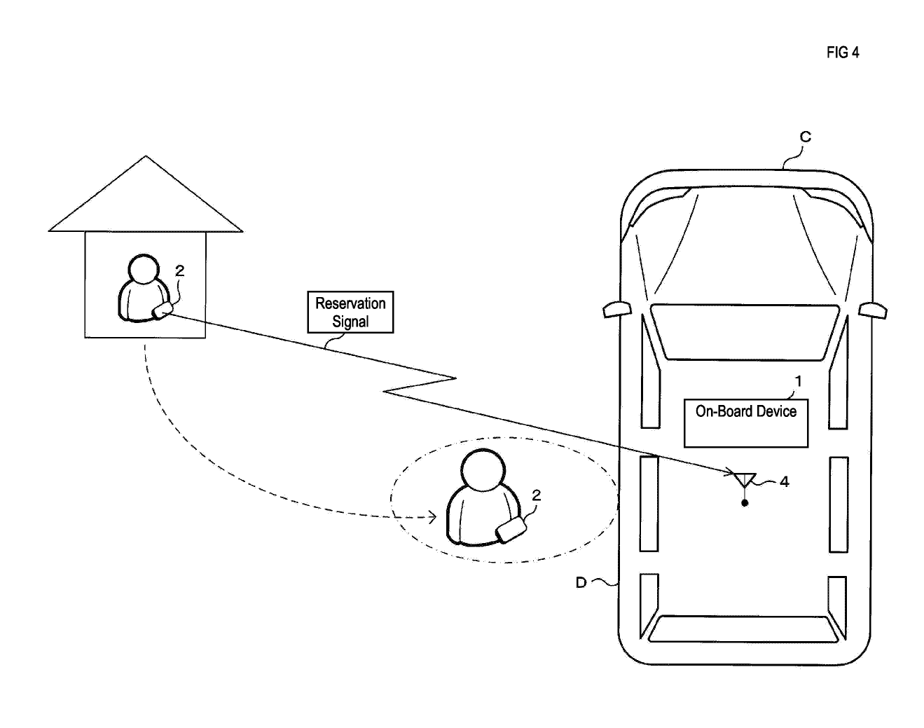

Next, an example of the usage of the vehicle communication system that has the above-described configuration will be described. FIG. 4 is a conceptual diagram showing an example of the usage of the vehicle communication system. First, the user who is holding the mobile device 2 operates the reservation switch 26 at a distance from the vehicle C, in a house for example, to cause the mobile device 2 to transmit a reservation signal. The on-board device 1, which has received the reservation signal via the RF reception antenna 4, repeatedly transmits a position detection signal.

Thereafter, the user moves toward the vehicle C, holding the mobile device 2. While the user is moving, upon the mobile device 2 entering the reach of the position detection signal from the on-board device 1, the mobile device 2 and the on-board device 1 communicate with each other. As a result of the communication, the on-board device 1 detects the positional relationship between the vehicle C and the mobile device 2, and determines whether or not the detected positional relationship matches the predetermined positional relationship stored in the storage unit 14. The predetermined positional relationship is, for example, a relationship in which the mobile device 2 is present within the range of 3 m or less from the outer surface of the sliding door D in a direction in which the outer surface faces, i.e. within the range surrounded by a one-dot chain line in FIG. 4. Upon determining that the positional relationship is not the predetermined positional relationship, the on-board device 1 transmits a position detection signal again, and determines whether or not the positional relationship of the mobile device 2 relative to the vehicle C matches the predetermined positional relationship as a result of the user moving. Upon determining that the positional relationship matches the predetermined positional relationship, the on-board device 1 causes the output unit 15 to output a door open instruction signal to open the sliding door D.

Upon receiving a reservation signal transmitted from the mobile device 2, the on-board device 1 successively detects the positional relationship between the mobile device 2 and the vehicle C until the positional relationship of the mobile device 2 relative to the vehicle C matches the predetermined positional relationship. Since the on-board device 1 performs such control, the user can open the sliding door D without operating the sliding door switch 5. Therefore, the user can easily open the sliding door D even if both hands are full, for example. Also, even if the mobile device 2 is present within the range of 3 m from the sliding door D, the on-board device 1 does not open the sliding door D if the mobile device 2 is not present at a position toward which the outer surface of the sliding door D faces. For example, the on-board device 1 does not open the sliding door D if the user is present at a position toward which a vehicle door on the passenger seat side faces. Therefore, when the user does not intend to open the sliding door D and intends to open a vehicle door on the passenger seat side, the sliding door D is prevented from being erroneously opened, which improves convenience and security. Furthermore, in the case where the user does not intend to open the sliding door D, the user can avoid opening the sliding door D even when the user moves to a position where the predetermined positional relationship is satisfied, by not operating the reservation switch 26, and thus it is possible to prevent the sliding door D from being unnecessarily opened. Next, processing procedures that are performed by the on-board device 1 will be described.

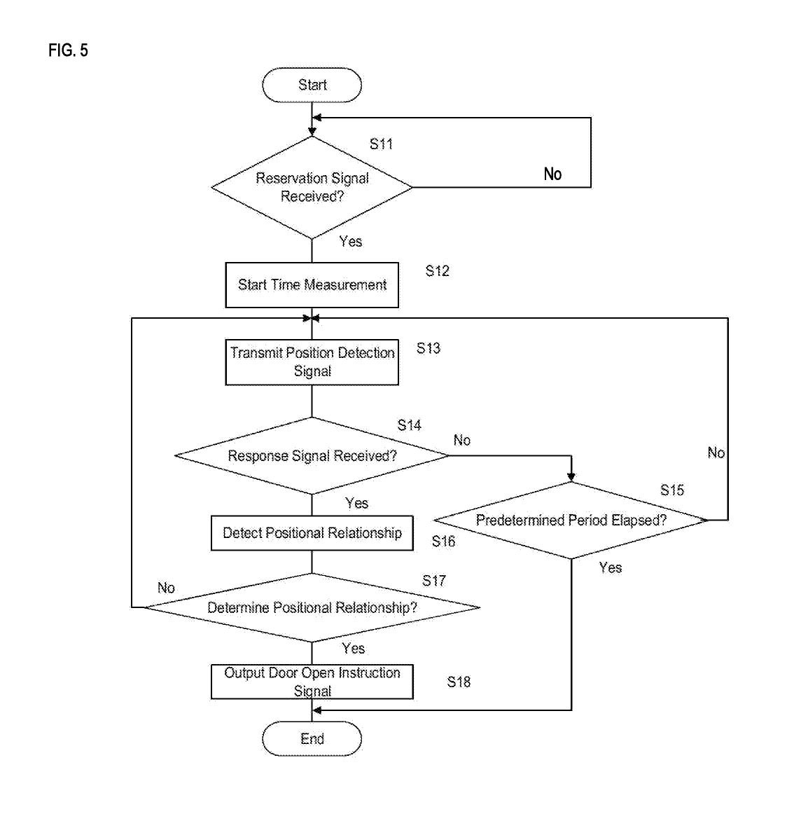

FIG. 5 is a flowchart showing processing procedures that are performed by the on-board device 1 to open the sliding door D based on a reservation signal from the mobile device 2. The on-board control unit 11 of the on-board device 1 determines whether or not the on-board reception unit 13 has received a reservation signal that has been transmitted from the mobile device 2 (step S11). The on-board control unit 11 performs the determination based on, for example, whether or not information that has been output from the on-board reception unit 13 contains information that indicates a reservation signal. Upon determining that the on-board reception unit 11 has not received a reservation signal (S11: NO), the on-board control unit 11 suspends processing until the on-board reception unit 11 receives a reservation signal.

Upon determining that the on-board reception unit 11 has received a reservation signal (S11: YES), the on-board control unit 11 instructs the timer 11a to start time measurement (step S12). Subsequently, the on-board control unit 11 causes the on-board transmission unit 12 to sequentially transmit position detection signals from the first to fourth LF transmission antennas 31, 32, 33, and 34 (step S13). The strength of the position detection signals transmitted from the first to fourth LF transmission antennas 31, 32, 33, and 34 is substantially the same. The on-board transmission unit 12 transmits a position detection signal from the first LF transmission antenna 31, and then transmits a position detection signal that has substantially the same strength as the aforementioned position detection signal, from the second LF transmission antenna 32. Similarly, the on-board transmission unit 12 transmits a position detection signal from the third LF transmission antenna 33, and then transmits a position detection signal from the fourth LF transmission antenna 34.

Using the reception signal strength measurement unit 25, the mobile device 2 measures the reception signal strengths of the position detection signals that have been transmitted from the first to fourth LF transmission antennas 31, 32, 33, and 34, and transmits response signals that contain the reception signal strengths obtained by performing the measurement, to the on-board device 1, using the mobile transmission unit 23.

Subsequently, the on-board control unit 11 determines whether or not the on-board reception unit 13 has received a response signal that corresponds to the position detection signals from the mobile device 2 (step S14). Upon determining that the on-board reception unit 11 has not received a response signal (S14: NO), the on-board control unit 11 determines whether or not a predetermined period has elapsed since the reception of the reservation signal (step S15). The on-board control unit 11 performs the determination by, for example, determining whether or not the predetermined period has elapsed since the on-board control unit 11 caused the timer 11a to start time measurement in step S12. The predetermined period is ten minutes, for example. Upon determining that the predetermined period has elapsed (S15: YES), the on-board control unit 11 ends processing, and upon determining that the predetermined period has not elapsed (S15: NO), the on-board control unit 11 returns processing to step S13.

On the other hand, upon determining that the on-board reception unit 11 has received a response signal (S14: YES), the on-board control unit 11 detects the positional relationship between the vehicle C and the mobile device 2 based on the received response signal (step S16). The on-board control unit 11 detects the positional relationship between the vehicle C and the mobile device 2 by, for example, detecting the positional relationship between the mobile device 2 and each LF transmission antenna 3, based on the reception signal strengths contained in the response signal. The on-board control unit 11 may detect, as the positional relationship between the vehicle C and the mobile device 2 based on the reception signal strengths, the distance between the vehicle C and the mobile device 2, or the coordinates of the mobile device 2 relative to the vehicle C at the origin. In step S16, the on-board control unit 11 serves as the detection unit by executing the control program stored in the storage unit 14.

Subsequently, the on-board control unit 11 determines whether or not the detected positional relationship between the vehicle C and the mobile device 2 matches the predetermined positional relationship (step S17). The on-board control unit 11 determines whether or not the positional relationship matches the predetermined positional relationship by, for example, determining whether or not the detected positional relationship indicates that the mobile device 2 is present within the range of 3 m or less from the outer surface of the sliding door D in a direction in which the outer surface faces. Upon determining that the positional relationship does not match the predetermined positional relationship (S17: NO), the on-board control unit 11 returns processing to step S13. Upon determining that the positional relationship matches the predetermined positional relationship (S17: YES), the on-board control unit 11 causes the output unit 15 to output a door open instruction signal to the door ECU 6 (step S18), and thereafter ends processing.

Note that when returning processing from the processing in step S15 or step S17 to the processing in step S13, the on-board control unit 11 may transmit a position detection signal immediately after returning processing to step S13, or transmit a signal when a predetermined period has elapsed after performing the processing in step S13. The predetermined period is several seconds, e.g. two seconds. Furthermore, the on-board control unit 11 may use a different transmission interval of a position detection signal when returning processing from the processing in step S15 to the processing in step S13 and when returning processing from the processing in step S17 to the processing in step S13.

With the above-described configurations and processing, the on-board device 1 can perform control to open the sliding door D depending on the detected positional relationship between the vehicle C and the mobile device 2. Therefore, the on-board device 1 can perform more flexible control compared to control that is performed to open the sliding door D simply depending on whether or not the mobile device 2 is present within a predetermined communication range. More specifically, the on-board device 1 detects the positional relationship including the distance, and can perform control to open a vehicle door on the condition that the user who is holding the mobile device 2 is present at a distance that is shorter than or equal to the detected distance, from the vehicle C. Therefore, the on-board device 1 can perform flexible control.

Also, the on-board device 1 transmits position detection signals from a plurality of LF transmission antennas 3 that are provided in the vehicle C. In the case of receiving a plurality of position detection signals, the mobile device 2 can increase the amount of information that can be contained in a response signal to be transmitted, compared to the case of receiving one position detection signal. Therefore, the on-board device 1 can accurately detect the positional relationship between the vehicle C and the mobile device 2. Also, the on-board device 1 can accurately detect the positional relationship based on a reception signal strength that is contained in the response signal.

Furthermore, since the on-board device 1 according to the first embodiment transmits a position detection signal upon receiving a reservation signal from the mobile device 2, it is possible to suppress the consumption of power from a power supply of the on-board device 1 mounted on the vehicle C, compared to the case where the position detection signal is transmitted regardless of whether or not a reservation signal has been received.

Note that the on-board device 1 may transmit a position detection signal constantly or intermittently without receiving a reservation signal. An on-board device 1 that performs such control achieves the same advantageous effects as those achieved by the on-board device 1 according to the first embodiment by not opening the sliding door D if a reservation signal is received, even if the detected positional relationship matches the above-described predetermined positional relationship.

Also, since the mobile device 2 transmits a reservation signal and a response signal by using a radio wave that is similar to the radio wave for an activation signal, the mobile device 2 can be formed using a mobile device that can activate the driving source of the vehicle C, such as a so-called remote engine starter. Therefore, the mobile device 2 according to the present embodiment can increase the reach of each signal, compared to the case where the mobile device 2 is formed using a mobile device for a so-called keyless entry system. Note that the mobile device 2 may be formed using a mobile device for a so-called keyless entry system, or formed as a mobile device that is dedicated to opening the sliding door D. Also, when transmitting a reservation signal and a response signal, the mobile device 2 does not necessarily use a radio wave that is similar to the radio wave for an activation signal.

### Second Embodiment

The second embodiment describes an example in which the on-board device 1 detects whether it is raining or not at the position where the vehicle C is present, and changes the condition for opening the sliding door D according to the result of the detection. Note that the configurations and the actions other than the configurations and the actions described below are the same as those in the first embodiment, and therefore detailed descriptions of the same configurations and descriptions of the actions and effects are omitted for the sake of simplification.

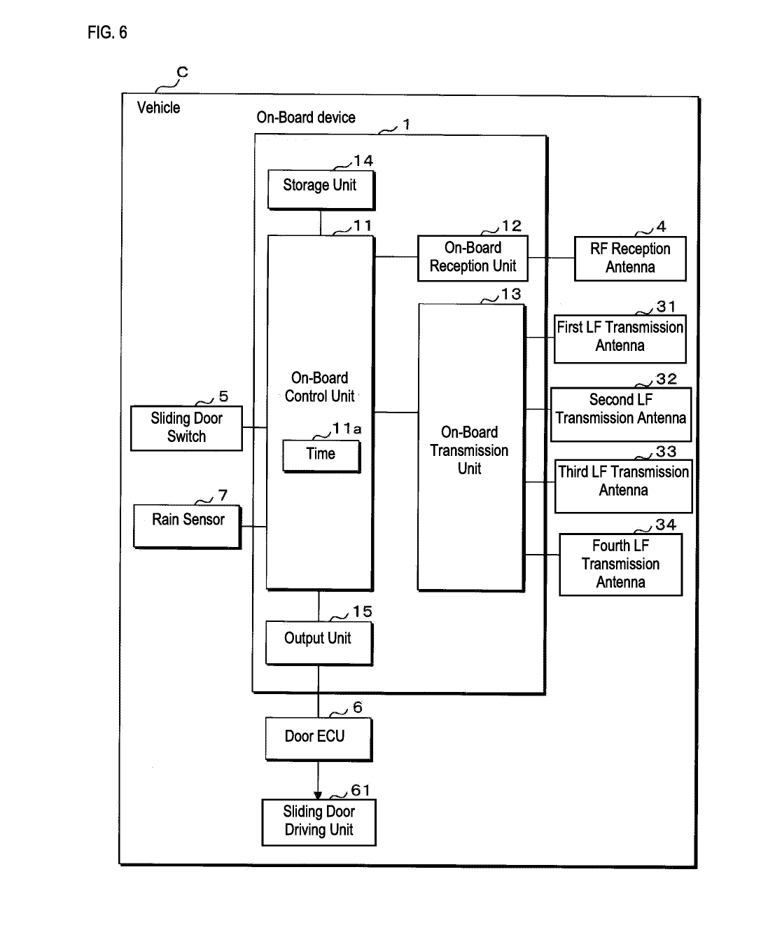

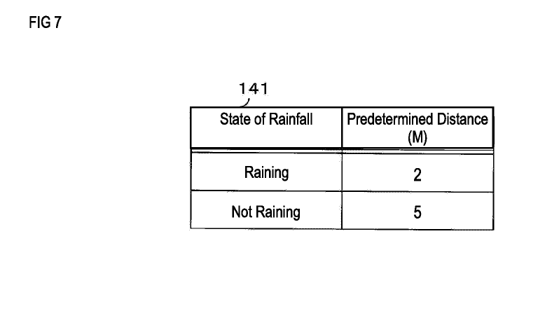

FIG. 6 is a block diagram showing an example of a configuration of an on-board device 1 according to the second embodiment, and FIG. 7 is a conceptual diagram showing an example of a correspondence table 141 that is stored in the storage unit 14. A rain sensor 7 is connected to the on-board control unit 11 of the on-board device 1 according to the second embodiment. The rain sensor 7 is an optical sensor, for example, and includes a light-emitting element that emits light toward the windshield of the vehicle C, a light emitter-side lens that converts light from the light-emitting element into parallel light to allow the light to be totally reflected off the outer surface of the windshield, and a light-receiving element that receives the light reflected by a window plate. The rain sensor 7 outputs a signal that corresponds to the amount of light received by the light-receiving element to the on-board control unit 11.

The on-board control unit 11 detects whether or not there are raindrops on the windshield of the vehicle C, based on an input signal from the rain sensor 7. That is, the on-board control unit 11 detects whether it is raining or not at the position where the vehicle C is present, based on the input signal from the rain sensor 7.

Also, the storage unit 14 stores the correspondence table 141 in which the state of rainfall and distances are associated with each other. The state of rainfall is information that indicates the degree of rainfall at the position where the vehicle C is present. As shown in FIG. 7, the correspondence table 141 stores, for example, information indicating the states of rainfall “raining” and “not raining” and information indicating distances “5 m” and “2 m”, in association with each other. Note that “5 m” and “2 m” are examples, and distances are not specifically limited. For example, information indicating the states of rainfall “raining” and “not raining” and information indicating distances “2 m” and “1 m” may be stored in the correspondence table 141 in association with each other.

Upon receiving a reservation signal from the mobile device 2, the on-board device 1 having the above-described configurations changes the condition for performing control to open the sliding door D according to the state of rainfall at the position where the vehicle C is present. The following describes processing procedures that are performed by the on-board device 1 to perform such control.

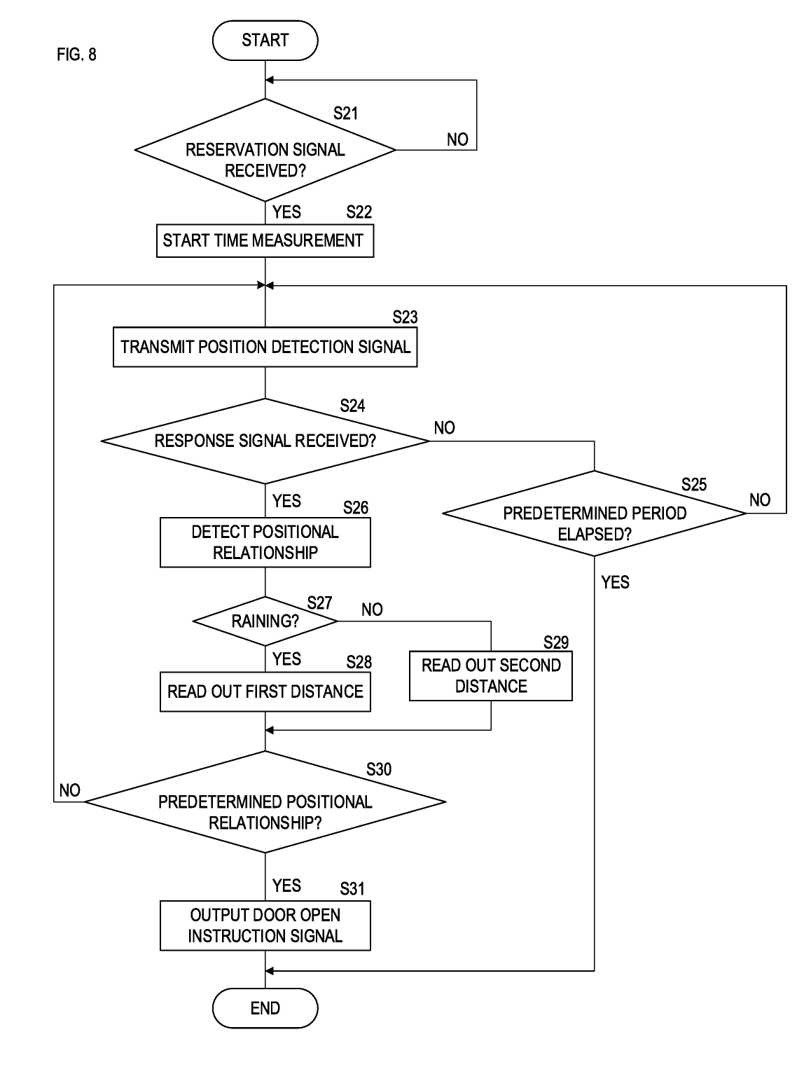

FIG. 8 is a flowchart showing processing procedures that are performed by the on-board device 1 to open the sliding door D based on a reservation signal from the mobile device 2. Note that the processing in steps S21 to S26 and S31 is the same as the processing in steps S11 to S16 and S18 in the first embodiment, and therefore descriptions thereof are omitted.

The on-board control unit 11 of the on-board device 1 detects the positional relationship between the vehicle C and the mobile device 2 in step S26, and thereafter detects whether it is raining or not at the position where the vehicle C is present, based on the input signal from the rain sensor 7 (step S27). The on-board control unit 11 serves as the environment detection unit by executing a control program in step S27.

Upon detecting that it is raining (S27: YES), the on-board control unit 11 reads out a first distance from the correspondence table 141 (step S28), and upon detecting the absence of rainfall (S27: NO), the on-board control unit 11 reads out a second distance from the correspondence table 141 (step S29). The first distance is a distance that is associated with “raining”, which is “2 m” in the example shown in FIG. 7. The second distance is a distance that is associated with “not raining”, which is “5 m” in the example shown in FIG. 7.

After performing the processing in step S28 or S29, the on-board control unit 11 determines whether or not the positional relationship between the vehicle C and the mobile device 2 detected in step S26 matches a predetermined positional relationship (step S30). The on-board control unit 11 determines whether or not the positional relationship matches the predetermined positional relationship by, for example, determining whether or not the mobile device 2 is present within the range of a predetermined distance or shorter from the outer surface of the sliding door D in a direction in which the outer surface faces. The predetermined distance is the first distance or the second distance, which is read out in step S28 or step S29. For example, upon reading out the distance “5 m” from the correspondence table 141 in step S28, the on-board control unit 11 determines, in step S30, whether or not the mobile device 2 is present within the range of 5 m from the outer surface of the sliding door D in a direction in which the outer surfaces faces. Alternatively, for example, upon reading out the distance “2 m” from the correspondence table 141 in step S29, the on-board control unit 11 determines, in step S30, whether or not the mobile device 2 is present within the range of 2 m from the outer surface of the sliding door D in a direction in which the outer surfaces faces.

Upon determining that the positional relationship does not match the predetermined positional relationship (S30: NO), the on-board control unit 11 returns processing to step S23, and upon determining that the positional relationship matches the predetermined positional relationship, the on-board control unit 11 proceeds processing to step S31.

With the above-described configurations and processing, the on-board device 1 can change the condition for opening the sliding door D, i.e., the distance between the vehicle C and the mobile device 2, depending on the external environment around the vehicle C on which the on-board device 1 is mounted, which further improves user convenience. More specifically, in the case where it is raining at the position where the vehicle C is present, the on-board device 1 delays opening the sliding door D, compared to the case where it is not raining at the position. Thus, the on-board device 1 can shorten the time during which raindrops can enter the vehicle, and can prevent the cabin of the vehicle from getting dirty due to raindrops, and prevent electrical equipment that is provided in the cabin of the vehicle from breaking down, for example, which further improves user convenience.

Although the correspondence table 141 according to the second embodiment has been described as being configured to store information indicating whether it is raining or not and a distance corresponding thereto, the correspondence table 141 may also store the degree of rainfall such as “light rain” and “heavy rain” and the distances corresponding thereto. If this is the case, the on-board device 1 may detect whether it is raining or not and the degree of rainfall in step S26 in FIG. 8, based on a signal from the rain sensor 7, and use the distance that corresponds to the degree of rainfall thus detected, to perform processing. By performing processing in such a manner, the on-board device 1 can change the distance between the vehicle C and the mobile device 2 used as the condition for opening the sliding door D depending on the degree of rainfall. Therefore, it is possible to further improve user convenience.

Although the on-board device 1 according to the second embodiment has been described as being configured to detect whether it is raining or not at the position where the vehicle C is present after receiving a reservation signal, the on-board device 1 may constantly or intermittently detect whether it is raining or not at the position where the vehicle C is present regardless of whether or not a reservation signal has been received.

Also, although whether it is raining or not at the position where the vehicle C is present is detected as the external environment in the second embodiment, another kind of external environment may be detected. For example, the on-board device 1 may detect the temperature, the brightness, and so on at the position where the vehicle C is present, as the external environment.

Although the predetermined positional relationship between the vehicle C and the mobile device 2 according to the first and second embodiments is described using a separation distance from the sliding door D to the mobile device 2 in a direction in which the sliding door D faces, another positional relationship may be employed, as long as at least the distance between the vehicle C and the mobile device 2 is indicated. For example, various kinds of positional relationships such as the coordinates, direction, or the like of the position at which the mobile device 2 is present, relative to the position at which the vehicle C is present, may be employed. For example, the on-board device 1 may be configured to detect the three-dimensional coordinates of the mobile device 2 or the two-dimensional coordinates of the mobile device 2 in a horizontal plane, relative to the vehicle C at the origin. Also, the predetermined positional relationship may be a combination of various positional indices that indicate a distance, coordinates, a direction, and so on.

Although the on-board device 1 according to the first and second embodiments is described as being configured to open the sliding door D depending on the positional relationship between the vehicle C and the mobile device 2, the door to be opened may be any of the vehicle doors provided for the vehicle C. For example, the on-board device 1 may perform control to open a vehicle door that is provided for the trunk of the vehicle C, depending on the positional relationship.

1. vehicle communication system comprising: an on-board device that outputs a control signal for opening a vehicle door; and a mobile device that transmits a reservation signal pertaining to a reservation for opening the vehicle door to the on-board device upon a reservation switch being operated, the on-board device outputting the control signal according to a position where the mobile device is present, upon receiving the reservation signal,
wherein the on-board device comprises:
a reservation signal reception unit that receives the reservation signal;
a request signal transmission unit that transmits a request signal that requests a response signal from the mobile device;
a response signal reception unit that receives the response signal that has been transmitted from the mobile device in response to the request signal that has been transmitted by the request signal transmission unit;
a detection unit that detects a positional relationship between the mobile device and a vehicle on which the on-board device is mounted, upon the response signal reception unit receiving the response signal from the mobile device, based on the received response signal; and
an output unit that outputs the control signal if the reservation signal reception unit receives the reservation signal and the positional relationship detected by the detection unit indicates that a distance between the mobile device and the vehicle is shorter than or equal to a predetermined distance, and
the request signal transmission unit intermittently transmits the request signal during a predetermined period upon the on-board device receiving the reservation signal.

2. The vehicle communication system according to claim 1,
wherein the on-board device further comprises:
an environment detection unit that detects an external environment around the vehicle,
wherein the predetermined distance is a distance that corresponds to the external environment detected by the environment detection unit.

3. The vehicle communication system according to claim 2,
wherein the environment detection unit detects whether it is raining or not at a position where the vehicle is present, and
the predetermined distance has been set to be shorter for a case where the environment detection unit detects that it is raining than for a case where the environment detection unit detects that it is not raining.

4. The vehicle communication system according to claim 1,
wherein the request signal transmission unit transmits the request signal from a plurality of antennas that are provided in the vehicle.

5. The vehicle communication system according to claim 1,
wherein the mobile device comprises:
a request signal reception unit that receives the request signal transmitted from the on-board device;
a measurement unit that measures a reception signal strength of the request signal received by the request signal reception unit; and
a response signal transmission unit that transmits the response signal that contains the reception signal strength measured by the measurement unit, and
the detection unit of the on-board device detects the positional relationship based on the reception signal strength contained in the response signal.

6. (canceled)

7. The vehicle communication system according to claim 1,
wherein the mobile transmission unit transmits an activation signal for activating a driving source of a vehicle on which the on-board device is mounted, to the vehicle.

8. An on-board device that receives a reservation signal pertaining to a reservation for opening a vehicle door, and outputs a control signal for opening the vehicle door depending on a position where a sender of the received reservation signal is present, the reservation signal being transmitted in response to a reservation switch of the sender being operated, the on-board device comprising:
a reservation signal reception unit that receives the reservation signal;
a request signal transmission unit that transmits a request signal that requests a response signal from the sender;
a response signal reception unit that receives the response signal that has been transmitted from the sender in response to the request signal that has been transmitted by the request signal transmission unit;
a detection unit that detects a positional relationship between the sender and a vehicle on which the on-board device is mounted, upon the response signal reception unit receiving the response signal from the sender, based on the received response signal; and
an output unit that outputs the control signal if the reservation signal reception unit receives the reservation signal and the positional relationship detected by the detection unit indicates that a distance between the sender and the vehicle is shorter than or equal to a predetermined distance, and
the request signal transmission unit intermittently transmits the request signal during a predetermined period upon the on-board device receiving the reservation signal.

9. The vehicle communication system according to claim 2, wherein the request signal transmission unit transmits the request signal from a plurality of antennas that are provided in the vehicle.

10. The vehicle communication system according to claim 3, wherein the request signal transmission unit transmits the request signal from a plurality of antennas that are provided in the vehicle.

11. The vehicle communication system according to claim 2, wherein the mobile device comprises:
a request signal reception unit that receives the request signal transmitted from the on-board device;
a measurement unit that measures a reception signal strength of the request signal received by the request signal reception unit; and
a response signal transmission unit that transmits the response signal that contains the reception signal strength measured by the measurement unit, and
the detection unit of the on-board device detects the positional relationship based on the reception signal strength contained in the response signal.

12. The vehicle communication system according to claim 3, wherein the mobile device comprises:
a request signal reception unit that receives the request signal transmitted from the on-board device;
a measurement unit that measures a reception signal strength of the request signal received by the request signal reception unit; and
a response signal transmission unit that transmits the response signal that contains the reception signal strength measured by the measurement unit, and
the detection unit of the on-board device detects the positional relationship based on the reception signal strength contained in the response signal.

13. The vehicle communication system according to claim 4, wherein the mobile device comprises:
a request signal reception unit that receives the request signal transmitted from the on-board device;
a measurement unit that measures a reception signal strength of the request signal received by the request signal reception unit; and
a response signal transmission unit that transmits the response signal that contains the reception signal strength measured by the measurement unit, and
the detection unit of the on-board device detects the positional relationship based on the reception signal strength contained in the response signal.

14. The vehicle communication system according to claim 2, wherein the mobile transmission unit transmits an activation signal for activating a driving source of a vehicle on which the on-board device is mounted, to the vehicle.

15. The vehicle communication system according to claim 3, wherein the mobile transmission unit transmits an activation signal for activating a driving source of a vehicle on which the on-board device is mounted, to the vehicle.

16. The vehicle communication system according to claim 4, wherein the mobile transmission unit transmits an activation signal for activating a driving source of a vehicle on which the on-board device is mounted, to the vehicle.

17. The vehicle communication system according to claim 5, wherein the mobile transmission unit transmits an activation signal for activating a driving source of a vehicle on which the on-board device is mounted, to the vehicle.
